(19) United States
(12) Patent Application Publication
(10) Pub. No.: US 2008/0014640 A1
(43) Pub. Date: Jan. 17, 2008

(54) Method to study bomolecular interactions under native condition by MALDI

(76) Inventor: Fenhong Song, North Potomac, MD (US)

Correspondence Address: Fenhong Song, 13841 Grey Colt Drive, North Potomac, MD, 20878, US

(21) Appl. No.: 11/827,885

(22) Filed: Jul. 12, 2007

Related U.S. Application Data
(60) Provisional application No. 60/830,304, filed on Jul. 12, 2006.

(51) Int. Cl. G01N 1/28

(52) U.S. Cl. 436/17

(57) ABSTRACT

A sample preparation method is disclosed for volatilization and mass spectrometric analysis of nonvolatile high molecular weight molecules. Buffered aqueous solutions of matrix at near physiological pH are disclosed for use in Matrix-assisted Laser Desorption and Ionization (MALDI). The new methods expanded the application of MALDI to study non-covalent protein complexes.

### CROSS-REFERENCE TO RELATED APPLICATION

This application claims priority to U.S. Provisional Application No. 60/830,304 filed on Jul. 12, 2006. The entire disclosure of the prior application is considered to be part of the disclosure of the instant application and is hereby incorporated by reference.

### FIELD OF THE INVENTION

The present invention relates to the field of mass spectrometry and more particularly to the field of study of biomolecular interactions by matrix-assisted laser desorption/ionization mass spectrometry.

### BACKGROUND OF THE INVENTION

Matrix-assisted laser desorption/ionization (“MALDI”) mass spectrometry provides for the spectrometric determination of the mass of poorly ionizing or easily fragmented analytes of low volatility by embedding them in a matrix of light-absorbing material. The matrix material, which is present in large excess relative to the analyte, serves to absorb energy from the laser pulse and to transform it into thermal and excitation energy to desorb and ionize the analyte. This technique was introduced in 1988 by Hillenkamp and Karas (Karas and Hillenkamp, Anal. Chem. 60:2299,1988) for use with large biomolecules. Since then, the art of MALDI mass spectrometry has advanced rapidly and has found applications in the mass determination of molecules ranging from small peptides, oligosaccharides and oligonucleotides to large proteins and synthetic polymers.

The standard approach for MALDI sample preparation has been to deposit a dilute solution of analyte and a highly concentrated solution of matrix material on a substrate. The analyte and matrix solutions may be thoroughly mixed before deposition (see, e.g., Beavis and Chait, Anal. Chem. 62:1836,1990) or may be deposited separately and mixed on the substrate. The sample drop is then allowed to dry on the probe tip or target. The typical matrix is sinapinic acid in 30-50% of acetonitrile with 0.1% TFA (pH less than 2). This condition in general will denature protein and protein complexes and disrupt the non-covalent interaction. In general the intact protein complexes will not be able to be detected using the traditional sample preparation of MALDI. With the whole genome of many organisms, including humans mostly completion, the next challenge involves the characterization of the gene products-proteins. Biomolecular interactions, such as protein-protein, protein-DNA and protein-RNA, protein and small ligands are involved in many biochemical processes. Little is known about the functions of most proteins that the genes encode, or how these proteins interact to control cellular functions.

Protein interactions are intrinsic to virtually every cellular process. Most proteins in cells function in multi-subunit complexes of proteins created by specific protein--protein interactions. As the characterization of protein—protein interactions requires the in vitro reassembly of multi-subunit protein complexes, it is important to have methods for characterization any protein complexes by mass spectrometry.

Some attempts have been made in the recent past to develop a better method for the detection of non-covalent complexes by MALDI. Juhasz and Biemann detected non-biospecific non covalent complexes of oligosaccharides with some basic peptides [Juhasz and Bienmann “Mass Spectrometric Molecular Weight Determination of Highly Acidic Compounds of Biological Significance via Their Complexes with Basic Polypeptides, Proc. Natl. Acad. Sci. USA. 91: 4333-4337, 1994]. By using different matrices and preparation techniques, studies of noncovalent complexes between peptide-peptide, DNA and metal ions, RNA, drugs and other peptides have also been demonstrated [Tang, et al., “Non-covalent protein-oligonucleotides Interactions Monitored by Matrix-assisted Laser Desorption/ionization Mass Spectrometry, Anal. Chem. 67: 4542-4548, 1995; Thiede and von Janta-lipinski, “Non-covalent RNA-peptide Complexes Detected by Matrix-assisted Laser Desorption/ionization Mass Spectrometry”, Rapid Commun. Mass Spectrom. 13: 1889-1894, 1998; Lin et al., “Characterization of the “Helix Clamp” Motif of HIV-1 Reverse Transcriptase using MALDI-TOF MS and Surface Plasmon Resonance”, Anal.Chem, 72: 2635-264, 2000]. Standard matrices buffered to physiological pH has found to be helpful. Human farnesyl protein transferase as a heterodimer has been detected by MALDI by using sinapinic acid in CAN-0.2 M Bis-tris (30:70) (pH=7) [Farmer and Caprioli, “Determination of Protein-protein Interactions by Matrix-assisted Laser Desorption/ionization Mass Spectrometry”, J. Mass Spectrom. 33: 697-704, 1998]. Woods at al detected the enzyme-peptide complex using a saturated solution of sinapinic acid in 1:1 ethanol-1M ammonium citrate [Woods, et al., “Matrix-Assisted Laser Desorption/Ionization of Non-covalently Bound Compound, Anal. Chem. 67: 4462-4665, 1995]. The peptides were dissolved in 1M ammonium citrate (pH 6.0) and enzymes in 3.2 M ammonium sulfate (pH 7). Recent work has showed that immune complex between β-lactoglobulin and polyclonal anti-β-lacoglobulin antibody was detected by MALDI. The sinapinic acid was dissolved in CH₃CN/H₂O (1:1, v/v) without addition of TFA [Schlosser, et al., “Determination of immune complexes by Matrix-assisted laser desorption/ionization mass spectrometry”, Rapid Commun. Mass Spectrom 17: 2741-2747, 2003]. The complex was prepared in 10 mM of ammonium acetate (pH 7.8). These prior art references all used organic solvent that in general will disrupt the non-covalent bio-molecular interaction. Less acidic matrices, ATT, DHAP, and THAP, have been found more successful. A very recent work showed that intact hemoglobin complex from whole human blood was detected by MALDI. Matrix solution for complex detection is 2,6-DHAP saturated in acetonitrile/20 mM ammonium acetate 1:3(v/v). When 6-aza-2-thiothymine was used without addition of any organic solvent, the intact non-covalent protein complex, RNAse S, the non-covalent complex of S-protein and S-peptide and specific dimmers of coiled-coil leucine zipper polypeptide were observed [Glocker, et al., “Chacrterization of specific noncovalent protein complexes by UV Matrix-assisted laser desorption/ionization mass spectrometry”, J. Mass Spectrom. 31:1221-1227,1996]. However, no general prior art methods for the observation of non-covalent complexes have been found and the applicability of different matrices to a given complexes in literature reports is often inconsistent. Thus, there is a need for a better sample preparation method to detect protein complexes.

### SUMMARY OF THE INVENTION

The present invention provide methods and compositions containing a matrix, a volatile additive, and preferably a volatile base in a solvent relating to the preparation of biopolymer samples in essentially aqueous solution and near pH 7, e,g. under native condition when mixing with protein and protein complexes for MALDI mass spectrometry [Song F, “A study of protein-protein interactions by Matrix-assisted laser desorption/ionization”, 18: 1086-1090, 2007].

In preferred embodiments, the matrix is selected from the group consisting of sinapinic acid, alpha-cyano-4-hydroxycinnamic acid, 2,5-dihydroxybenzoic acid, 3-hydroxypicolinic acid, 5-(trifluoro-methyl)uracil, caffeic acid, succinic acid, anthranilic acid, 3-aminopyrazine-2-carboxylic acid, ferulic acid, 7-amino-4-methyl-coumarin, and 2-(4-hydroxyphenylazo)-benzoic acid.

In other preferred embodiments including these listed above the volatile additives are selected from the group consisting of ammonium citrate, ammonium hydrogen citrate, ammonium citrate, ammonium hydrogen citrate, ammonium bicarbonate, ammonium carbonate, ammonium acetate, ammonium tartarate or their alkylamine derivatives.

In other preferred embodiments including these listed above, the solvent is water.

### BRIEF DESCRIPTION OF THE DRAWINGS

The following drawings are included to further demonstrate certain aspects of the present invention. The invention may be better understood by reference to one or more of these drawings in combination with the detailed description of specific embodiments presented herein.

FIG. 1 MALDI Spectrum of PhzD

FIG. 2. MALDI Spectrum of Protein HI0719

FIG. 3 MALDI Spectrum of a class II Major Histocompatibility Complex

FIG. 4. MALDI Spectrum of Avidin

FIG. 5. MALDI Spectrum of the Complex of Superantigen (SAG) with Peptide-bound Major Histocompatibility (MHC) molecule

FIG. 6. MALDI Spectrum of the Complex of Peptide-linked T Cell Receptor (TCR) and MHC molecule

FIG. 7a. MALDI spectrum of Trypsin (6.3 uM) with Bovine Pancreatic Trypsin Inhibitor (BPTI) (25 uM)

FIG. 7b. MALDI Spectrum of Trypsin (2.4 uM) with Bovine Pancreatic Trypsin Inhibitor (BPTI) (10 uM)

FIG. 7c. MALDI Spectrum of Trypsin (0.63 uM) with Bovine Pancreatic Trypsin Inhibitor (BPTI) (2.5 uM)

FIG. 8a. MALDI Spectrum of Chymotrypsin (6.3 uM) With BPTI (25 uM)

FIG. 8b. MALDI Spectrum of Chymotrypsin (2.5 uM) With BPTI (10 uM)

FIG. 8c. MALDI Spectrum of Chymotrypsin (0.63 uM) With BPTI (2.5 uM)

FIG. 9a. MALDI Spectrum of Trypsinogen (6 uM) With BPTI (25 uM)

FIG. 9b. MALDI Spectrum of Trypsinogen (2.5 uM) With BPTI (10 uM)

FIG. 9c. MALDI Spectrum of Trypsinogen (0.63 uM) With BPTI (2.5 uM)

FIG. 10. MALDI Spectrum of the Spectra of Complexes of Trypsin, Chromotrypsin and Trypsinogen in Equal Molar Ratio with BPTI.

### DETAILED DESCRIPTION

The invention generally provides a sample preparation method which retain the native solution structure of proteins and their complexes by using aqueous solutions at near physiological pH for determining the mass or mass change of analytes, such as proteins, protein-protein complexes, protein-peptide or protein-DNA complexes samples and MALDI spectra were obtained. Although formation of non-covalent complexes in the presence of a neutral pH and aqueous solvent may not be the only factors for desorption of intact protein complexes in MALDI, in general it should be one of the prerequisites for the process. Thus acidic MALDI matrices and the presence of organic solvent may play a role in the dissociation of these complexes and prevent their observation. In this invention, aqueous solutions of acidic matrices were neutralized to raise the pH to a range that does not interfere with non-covalent complexes formation.

The method typically includes contacting analytes such as protein complex solution with a matrix solution comprising a matrix, a volatile salt as the additive, solvent essentially water, and a volatile base to adjust the pH of the solution close to physiological pH when necessary, and evaporating the solvent to provide a solid crystalline matrix containing the protein complexes to be analyzed. This contacting step may be carried out by adding the protein complexes to be analyzed to a solution containing the matrix and the additives. The matrix: additives : protein complexes mixture is then irradiated by a light source, such as a laser, to desorb, ionize, and produce an ionized protein or protein complexes. The laser used to desorb and ionize the large organic molecule may be any laser but is preferably a pulsed laser. Preferably, the pulse of energy comprises light having a wavelength of about 355 nm. The mass of the protein complexes may then be determined by summing the mass spectra over a number of laser pulses, preferably about 50 laser pulses or about 100 laser pulses. While any mass spectrometry is contemplated for use with the present invention, time-of-flight mass spectrometry is preferred.

In creating the matrix: protein complex: additive mixture, for example, by mixing protein complexes solution with the matrix solution containing the matrix, additive and base, one of skilled in the art will understand that the matrix solution containing the matrix may contain one or more additives and also one base or more bases. To perform the mixing, different ratios of matrix solution to protein or protein complex solution may be attempted and employed to create best result for the ionization. Dilution of the protein complexes samples with addition of high ratios of matrix such as 2/1. or 5/1 may help reduce the non-volatile buffer concentration in the protein complexes solution, such as tris buffer, phosphate buffer that are typically presented in the protocol of protein preparations to less than 20 mM. The typical concentrations of the protein complexes are in the range of a few uM to one hundred uM. After the matrix: protein complexes: additive mixture in solution is formed, the solvents are substantially evaporated, typically to dryness.

In preferred embodiments, the matrix is selected from the group consisting of sinapinic acid, alpha-cyano-4-hydroxycinnamic acid, 2,5-dihydroxybenzoic acid, 3-hydroxypicolinic acid, 5-(trifluoro-methyl)uracil, caffeic acid, succinic acid, anthranilic acid, 3-aminopyrazine-2-carboxylic acid, ferulic acid, 7-amino-4-methyl-coumarin, and 2-(4-hydroxyphenylazo)-benzoic acid. The combinations of the matrices may also be employed. The matrix solution in general is a saturated solution that was prepared by addition of 25 mg of the matrix compound to 0.5 to 1 mL of water. For some application or when this method is used with other method such as depositing matrix layers on targets or atmospheric pressure-MALDI, low concentration of matrix such as 1-10 mg/mL may be employed.

The additives for use in the present invention are generally a volatile salt or salts. Preferably additives are ammonium salts such as ammonium citrate, ammonium hydrogen citrate ammonium bicarbonate, ammonium carbonate, ammonium acetate, ammonium tartarate or their alkylamine derivatives, a typical concentration may range from 20 mg to 200 mg /mL, preferably 50 mg to 100 mg for 1 mL of solvent. The combinations of the additives may also be employed.

Amount of base need for adjusting the pH of the matrix solution to 6.0-8.5 may be 5 to 15 uL concentrated ammonium hydroxide for 1 mL of matrix solution. Any other nonvolatile base, such as diluted sodium hydroxide such as less than 10 uL of 0.01N solution or mixed base solutions may also be employed to adjust the pH from 6.0 to 8.5. This small amount of base is used only for pH adjustment and will not suppress the ionization of the analytes by MALDI.

The preferable solvent is water. Less than 5% of organic solvent that is selected from wherein said the organic solvent comprises methanol, ethanol, acetonitrile, dimethylsulfone or the combinations may also be employed. Protein complexes contemplated for analysis using the present invention may include protein-protein complexes, protein and a vast array of large organic molecule complexes that may contain polynucleic acids, polypeptides, oligosaccharides, peptide nucleic acid. The protein complexes may be isolated from cell lysate by affinity purification or other methods, may also be resembled with recombinatory proteins. It can be receptor-ligand, antibody-antigen, enzyme or its inhibitor. The mass spectrometry may be accomplished by one of several techniques such as time-of-flight, magnetic sector or ion trap. Preferably, the mass spectrometry technique for use with the present invention will be time-of-flight. The method disclosed here may be used to screen the protein-protein association and protein complexes dissociation by synthetic small molecule, fat acid, lipid, polynucleic acids, polypeptides or proteins, oligosaccharides, PNA.

The method here may also be used to estimate the relative affinities of the protein complexes. By dilution of the complex from 10 uM or 100 uM to sub-micromolar or lower, the micromolar binding complexes will be dissociated in solution. So the complex peaks from the complexes will be disappeared while these peaks from nanomolar binding complexes will still retain. It may also be used to compare the relative affinity of binding pairs by addition of an antigonist to observe the change of complexes peak intensities. Future advance in more sensitive detectors may allow the determination of binding constant at much lower level this way.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### EXAMPLE 1

### Material and Methods

The experiments were performed using Voyager-DE (Applied Biosystems, Inc., Framingham, Mass.) MALDI-TOF instrument equipped with 337 nm nitrogen laser. The flight path length of the instrument is 1.2 m. All mass spectra were acquired in positive ion linear mode with an acceleration voltage of 25 kV. The delay time was varied in the ranges of 450 ns to 1000 ns. Mass spectra were obtained by averaging 50 laser shots. The matrix solution was prepared by adding 25 mg of sinapinic acid and 50 mg ammonium citrate in 1 mL of deionized water to give a saturated solution, then adjusted to pH 7 with about 7 μL of concentrated ammonium hydroxide. Typically, an equal volume of complex solution and matrix solution were mixed at RT. The final mixture was vortexed. Typically four sample spots were deposited on a 100 well plate by loading 1 μL of the final analyte mixture and evaporated to dryness. Multiple measurements were taken to verify the reproducibility of the results. The instrument was calibrated using horse myoglobin.

### EXAMPLE 2

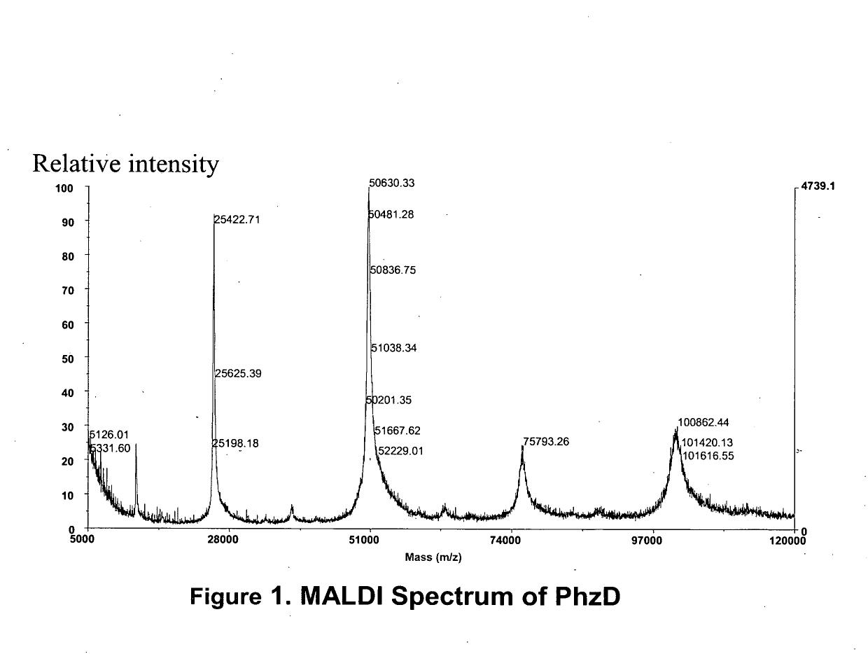

The procedure of example 1 was followed. Pseudomonas aeruginosa PhzD was supplied as a solution with a protein concentration of 10 mg/mL in 50 mM of Tris-HCl, 0.1 M of NaCl, 1 mM of DTT and 1 mM EDTA and was prepared as described by Parsons et al. [Parsons, et al., “Structure and Mechanism of Pseudomonas Aeruginosa PhzD, an Isochorismatase from the Phenazine Biosynthetic Pathway”, Biochemistry. 42: 5684-5693, 2003]. It was diluted with matrix solution to a concentration of 20 μM for a typical experiment. Pseudomonas aeruginosa PhzD, is an isochrorismatase from phenazine biosynthetic pathway. The crystal structure has been solved and it is a dimer in solid state. The solution molecular mass of this enzyme was determined by a combination of light scattering and interferometric refractometry and it is also a dimer in solution. The MALDI spectrum of this enzyme (FIG. 1), using sample preparation described here showed a major peak of homodimer at m/z 50 k, a major peak at 25 k of monomer with minor peaks from other high order of oligomers such as trimer, tetramer.

### EXAMPLE 3

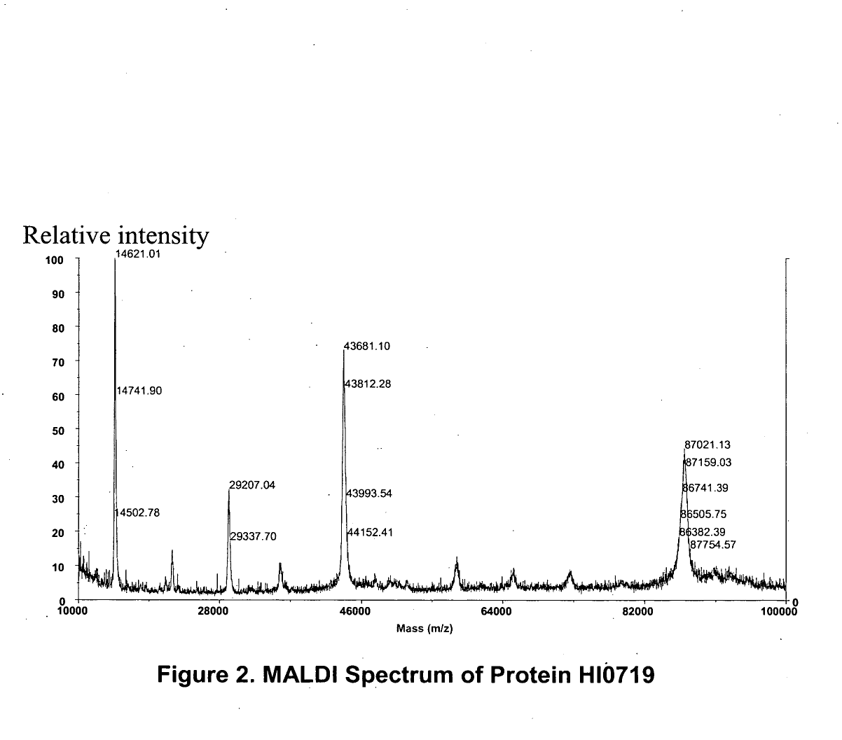

The procedure of example 1 was followed. The second sample tested is protein HI0719, which belongs to a family of proteins are widely distributed in bacteria, archaea, plants and eukaryote. HI0719 is a hometrimer by light scattering measurement and was proved as a trimer by solution NMR study. It was diluted with matrix solution to a concentration of 20 μM for a typical experiment. The spectrum of this sample (FIG. 2) show a trimer peak at m/z 43 k, which indicates the major multimeric form of protein 719 is a trimer, with less intense dimmer peak and the major monomer peak. At least a fraction of the monomer and dimmer peaks is probably from the dissociation of the trimer. This protein is known as a trimer in solid state by X-ray crystallography.

### EXAMPLE 4

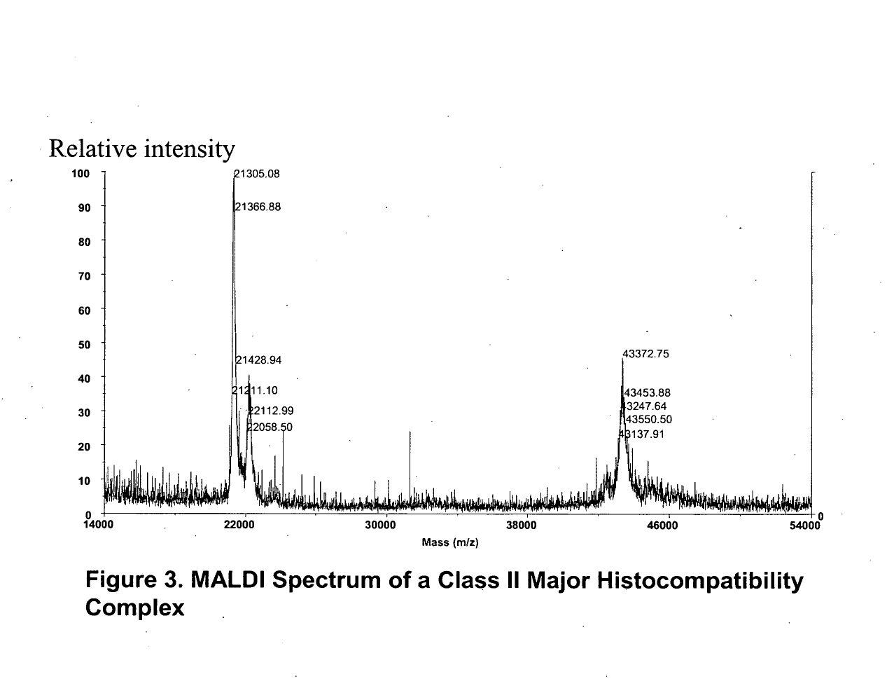

The procedure of example 1 was followed except that the matrix solution was prepared by adding 25 mg of sinapinic acid and 50 mg ammonium citrate in 1 mL of deionized water to give a saturated solution with a pH 6 without addition of concentrated ammonium hydroxide. This sample tested is a class II major histocompatibility complex (MHC), a known heterodimeric proteins. MHC proteins are cell surface proteins that serve as restricting elements for the cell-meditated immune system. The peak from the expected heterodimmer at m/z 43 K was observed in FIG. 3. Little homodimer peaks were observed, which indicates the specific nature of the binding.

### EXAMPLE 5

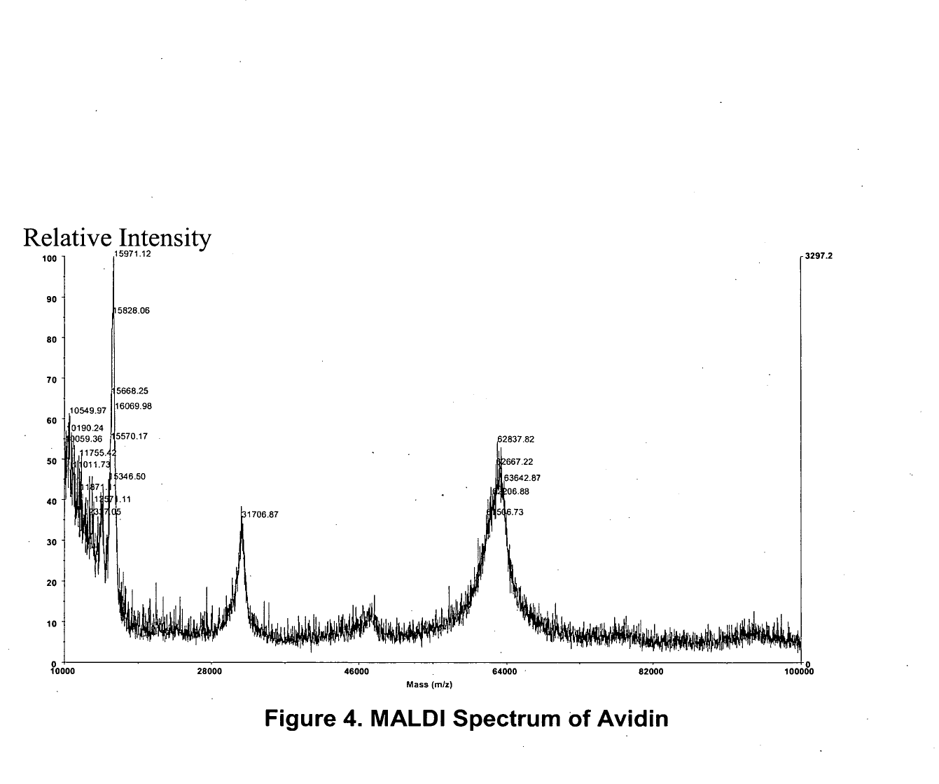

The procedure of example 1 was followed. Avidin was dissolved in deionized wafer to yield a protein concentration of 80 μM. This solution was diluted with equal volume of matrix solution to give the final concentration (40 μM). Avidin is a glycoprotein found in egg white whose active form is a tetramer composed of identical subunits. Each subunit contains 128 amino acids. The spectrum (FIG. 4) showed the tetramer peaks at m/z 63.1 k as the major peak in addition to the monomer at m/z 15.7 k and a minor dimer peak at m/z 31.7 k. Trace amount of trimer peak was also observed. These lower order oligomers are probably from the dissociation of the tetramer under the laser irradiation. However, the fact that the tetramer is the predominant species suggests that the basic solution structure of avidin is retained. These results are consistent with previous elactrospray and MALDI work where it was also observed as a tetramer.

### EXAMPLE 6

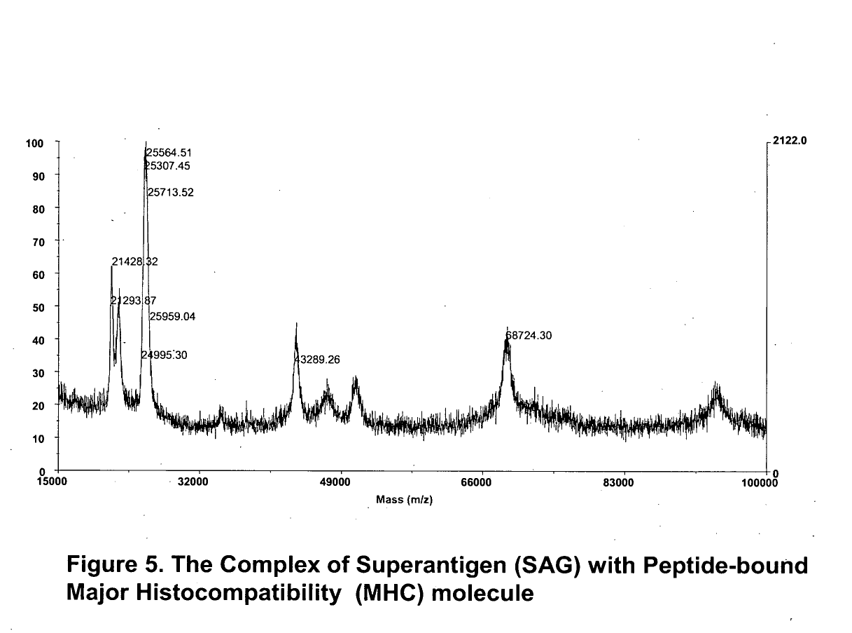

Sample 5 is a complex of SUPERANTIGEN (SAG) with peptide-bound major histocompatibility complex (MHC) class II molecule and was prepared as described by Deng et al. The concentration of complex one is 50 uM with 20 mM of tries buffer and 20 mM of sodium chloride. The sample was prepared by mixing 2 uL of the matrix solution and 2 uL of the complexes sample. Then 1 uL of the final mixture was loaded on the sample plate for MALDI. After evaporation of the solvent, the sample was loaded into the mass spectrometer. The concentration of the second sample is 12 uM. The MALDI spectrum (FIG. 5) of the first complex showed a peak at m/z 68K from the complex of SAG at m/z 25 k and MHC at m/z 43 k. Other peaks observed are SAG at m/z of 25 k, α-chain at m/z 22 k and α-chain at m/z 21 k of MHC, small peaks at m/z 43 k for MHC and m/z 47 k peak which is probably from dissociation of one chain of MHC molecule from the 68 k complex, and also the peak at m/z 50 k which is probably the dimer of SAG. The ionization of this immune complexes was also examined using sample preparation condition with 30% of acetonitrile at pH 2. The high order peaks at m/z 68 k was not observed.

### EXAMPLE 7

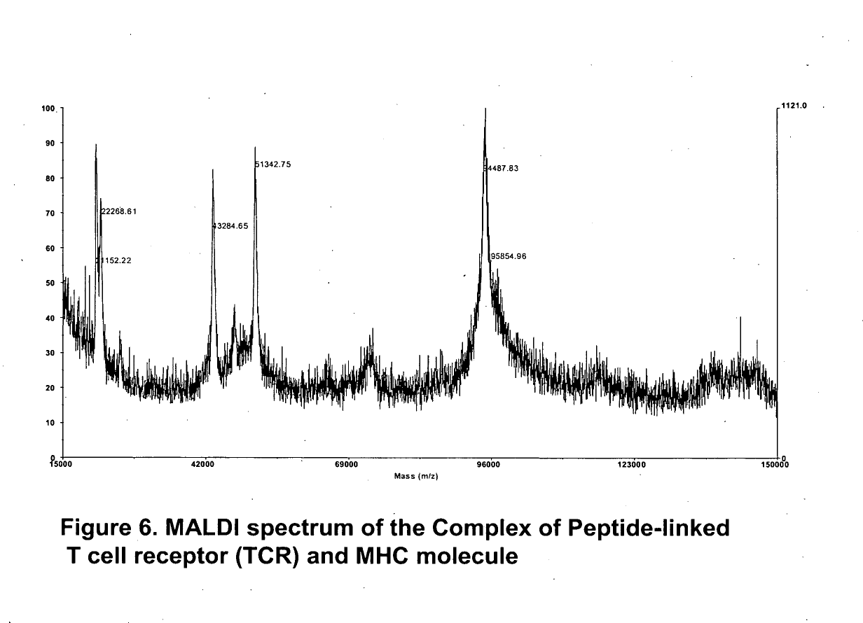

Sample 6 is a complex of peptide-linked T-cell receptor (TCR) and MHC class II molecule and was prepared and purified by size exclusion chromatograph as described by Deng et al. The sample was prepared by mixing 2 uL of the matrix solution and 2 uL of the complexes sample. Then 1 uL of the final mixture was loaded on the sample plate for MALDI. After evaporation of the solvent, the sample was loaded into the mass spectrometer. The final concentration is 12 uM. For this complex, a peptide-linked TCR with a MHC molecule, a peak at m/z 94 k was observed for the three component complexes (FIG. 6). Other peaks observed include peptide-linked TCR at m/z 51 k, m/z 43 k for MHC molecule, dissociated cc-chain of HMC at m/z 22 k and β-chain at m/z 21 k. The ionization of this immune complexes was also examined using sample preparation condition with 30% of acetonitrile at pH 2. The high order peaks at m/z 94 k was not observed.

### EXAMPLE 8

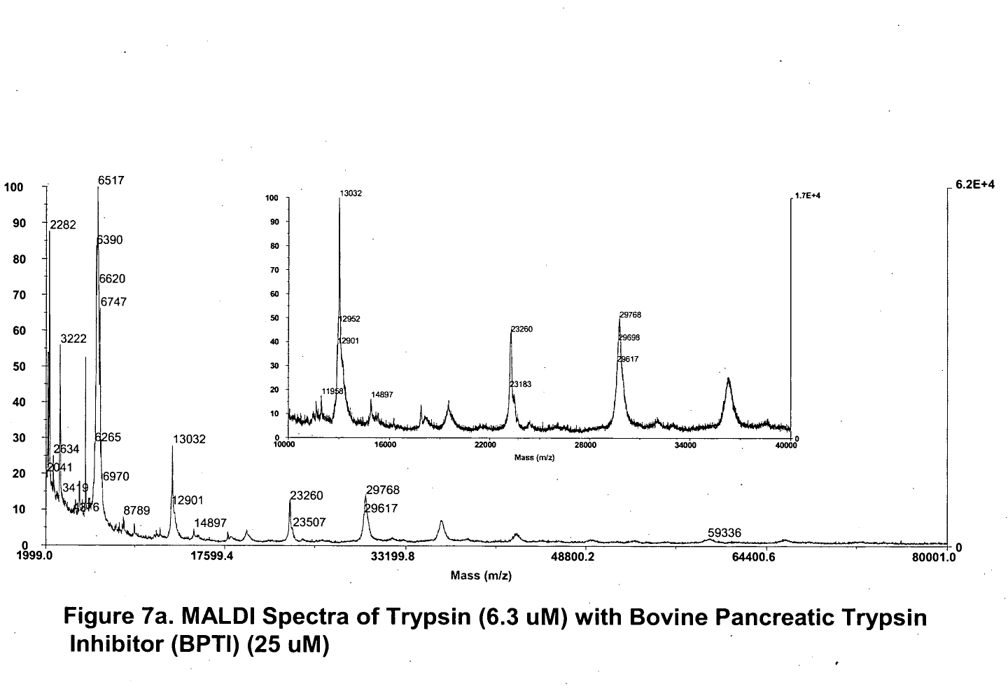

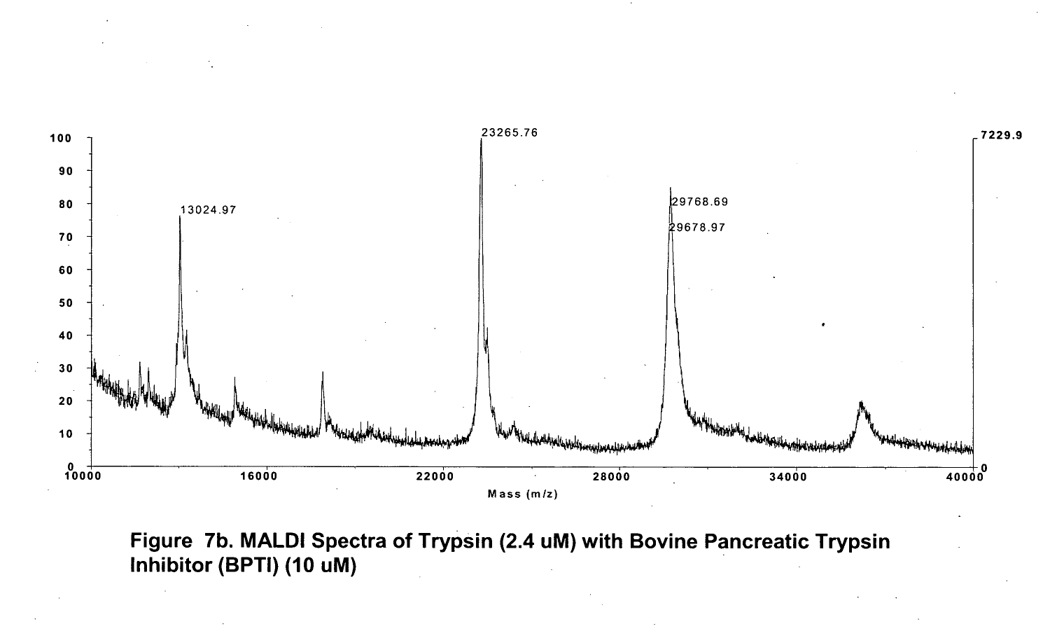

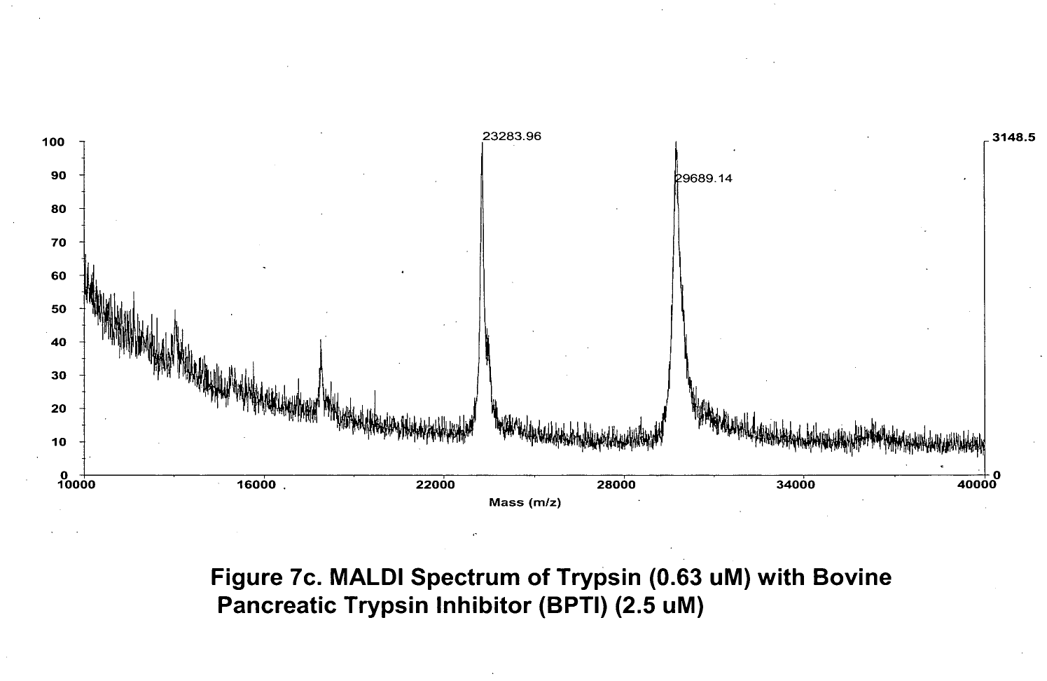

Bovine pancreatic trypsin inhibitor, trypsin were purchased from Sigma-aldrich. The typical matrix solution was prepared by adding 25 mg of the sinapinic acid and 50 mg of ammonium citrate or ammonium hydrogen citrate in 1 mL of deionized water to give a saturated solution, then adjusted to pH 7 with ammonium hydroxide. When bovine pancreatic trypsin inhibitor (BPTI, MW 6553) 2 uL of 200 uM in water was mixed with 2 ul of the enzymes in concentration of 50 uM in water, followed by the addition of 12 ul of matrix solution. The final mixture was vortexed. Four sample spots were prepared by loading 1 uL of the final analyte mixture. The corresponding complexes were e detected at m/z 29768 (FIG. 7a). The trypsin complex was observable after 2.5 more times dilution of the reaction mixture with the matrix solution, the complex peak was still observed (FIG. 7b). When it was further diluted 4 more times after 2.5 times dilution above with the matrix solution, the complex peak was still observed (FIG. 7c).

### EXAMPLE 9

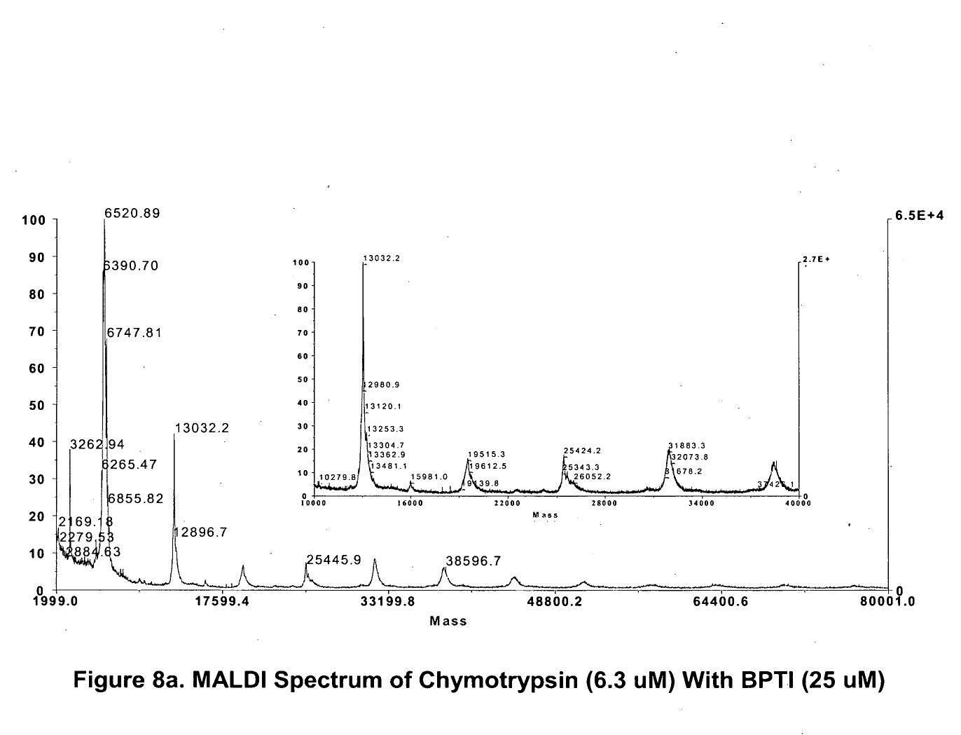

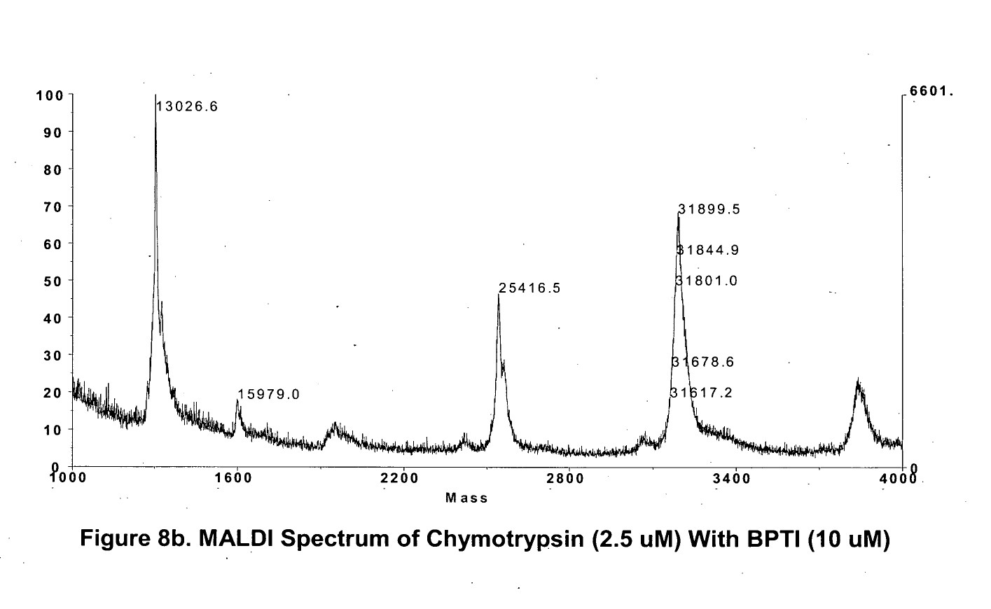

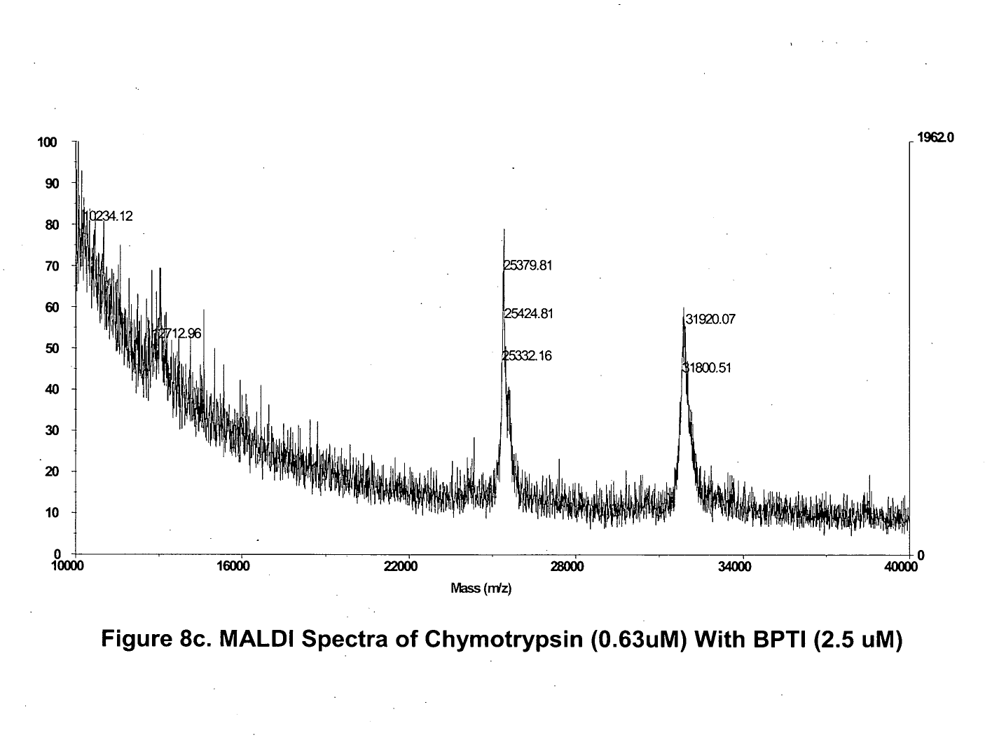

Bovine pancreatic trypsin inhibitor, chymotrypsin were perchased from Sigma-aldrich. The typical matrix solution was prepared by adding 25 mg of the sinapinic acid and 50 mg of ammonium citrate or ammonium hydrogen citrate in 1 mL of deionized water to give a saturated solution, then adjusted to pH 7 with ammonium hydroxide. When bovine pancreatic trypsin inhibitor (BPTI, MW 6553) 2 uL of 200 uM in water was mixed with 2 uL of the enzymes in concentration of 50 uM in water, followed by the addition of 12 uL of matrix solution. The final mixture was vortexed. Four sample spots were prepared by loading 1 uL of the final analyte mixture. The corresponding complex was detected at m/z 31883 (FIG. 8a). The complex was observable after 2.5 more times dilution of the reaction mixture with the matrix solution (FIG. 8b). When it was further diluted 4 more times after 2.5 times dilution above with the matrix solution, the complex peak was still observed (FIG. 8c).

### EXAMPLE 10

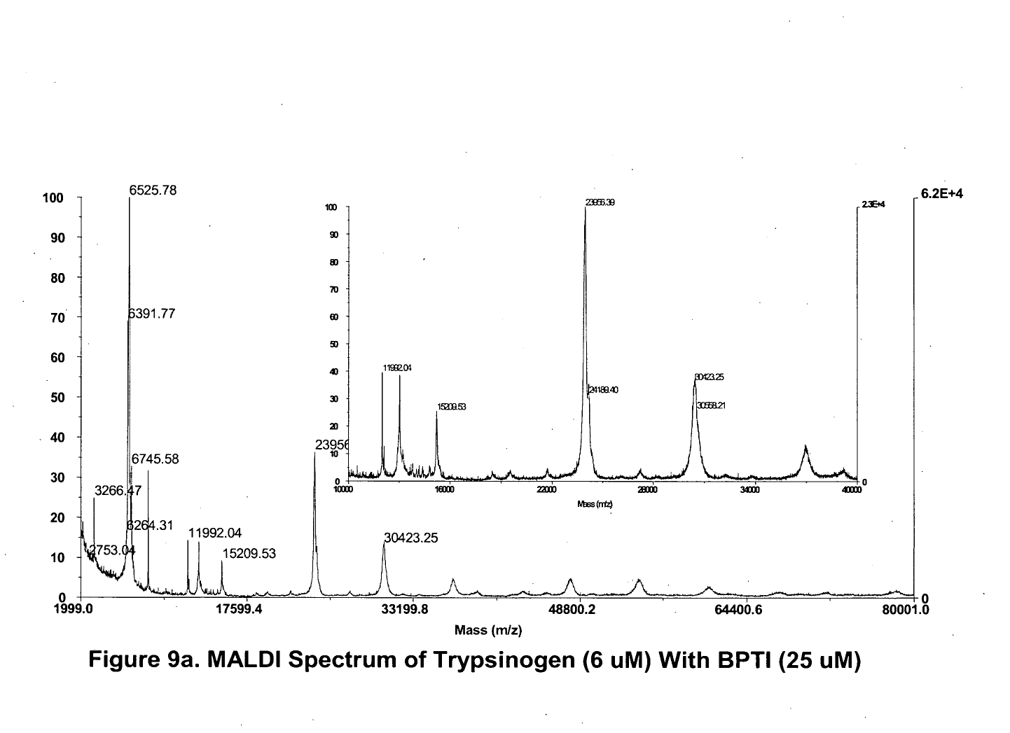

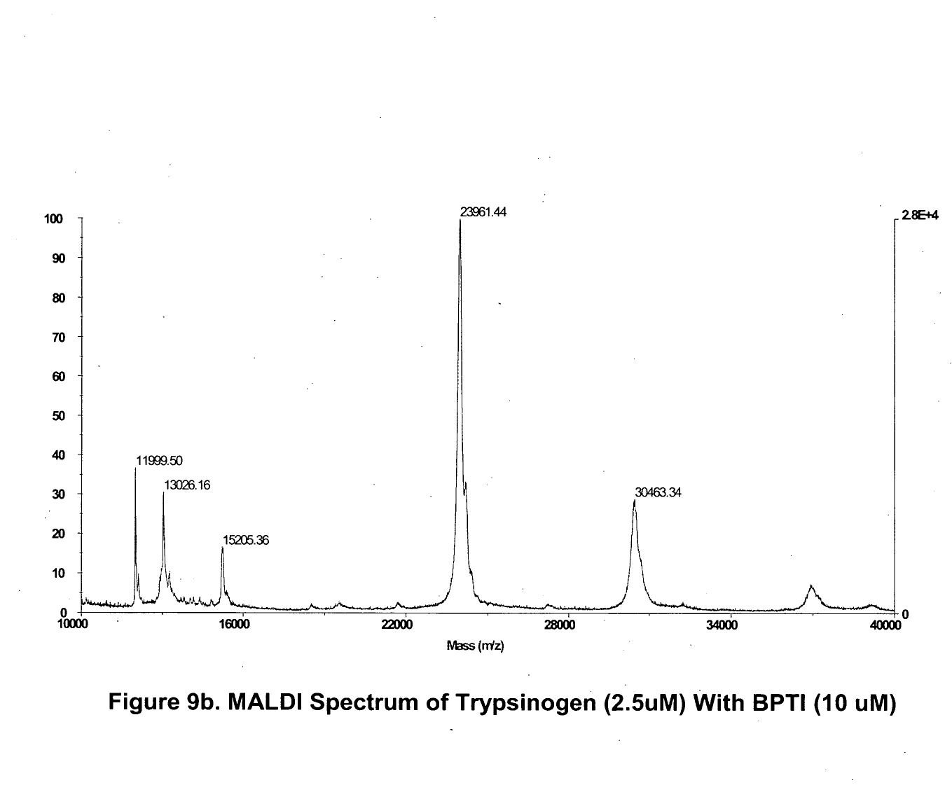

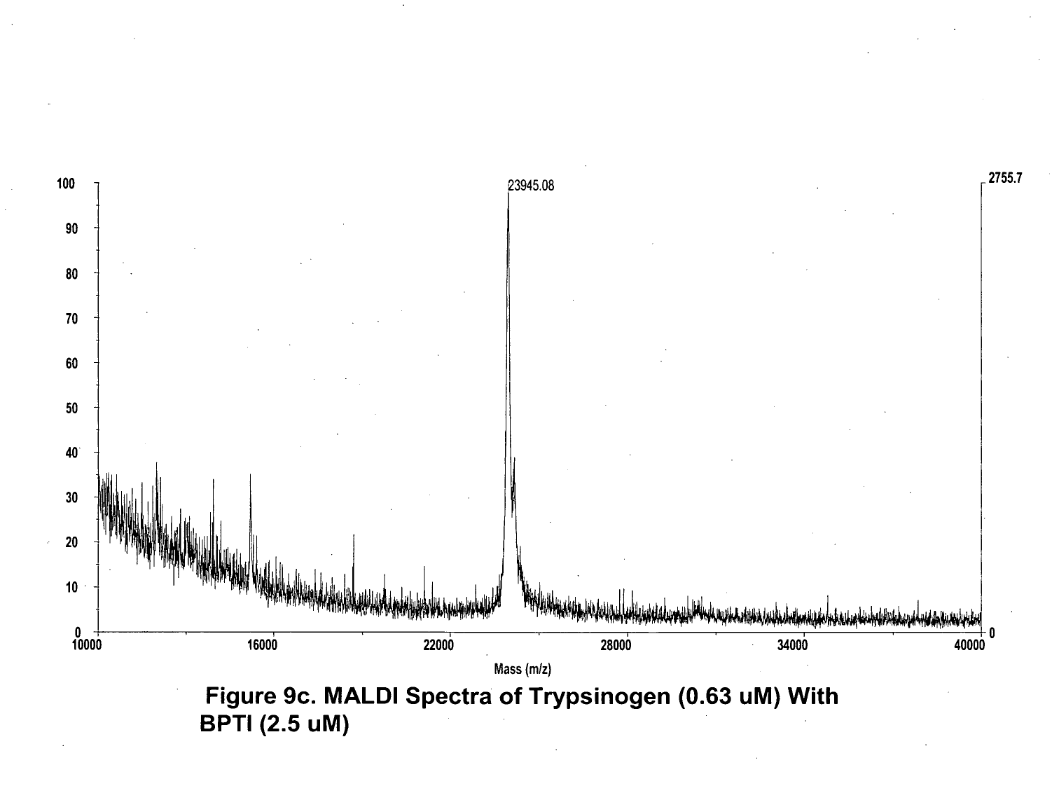

Bovine pancreatic trypsin inhibitor, trypsinogen were purchased from Sigma-aldrich. The matrix solution was prepared by adding 25 mg of the sinapinic acid and 50 mg of ammonium citrate or ammonium hydrogen citrate in 1 mL of deionized water to give a saturated solution, then adjusted to pH7 with ammonium hydroxid. When bovine pancreatic trypsin inhibitor (BPTI, MW 6553) 2 uL of 200 uM in water was mixed with 2 ul of the enzymes in concentration of 50 uM in water, followed by the addition of 12 ul of matrix solution. The final mixture was vortexed. Four sample spots were prepared by loading 1 uL of the final analyte mixture. The corresponding complex was detected at m/z 30423 (FIG. 9a). The trypsinogen complex was observable after 2.5 more times dilution with the matrix solution (FIG. 9b). However, when it was further diluted 4 times with the matrix solution, the complex was not observed (FIG. 9c) which may indicate that the Kd is in the micromolar range.

### EXAMPLE 11

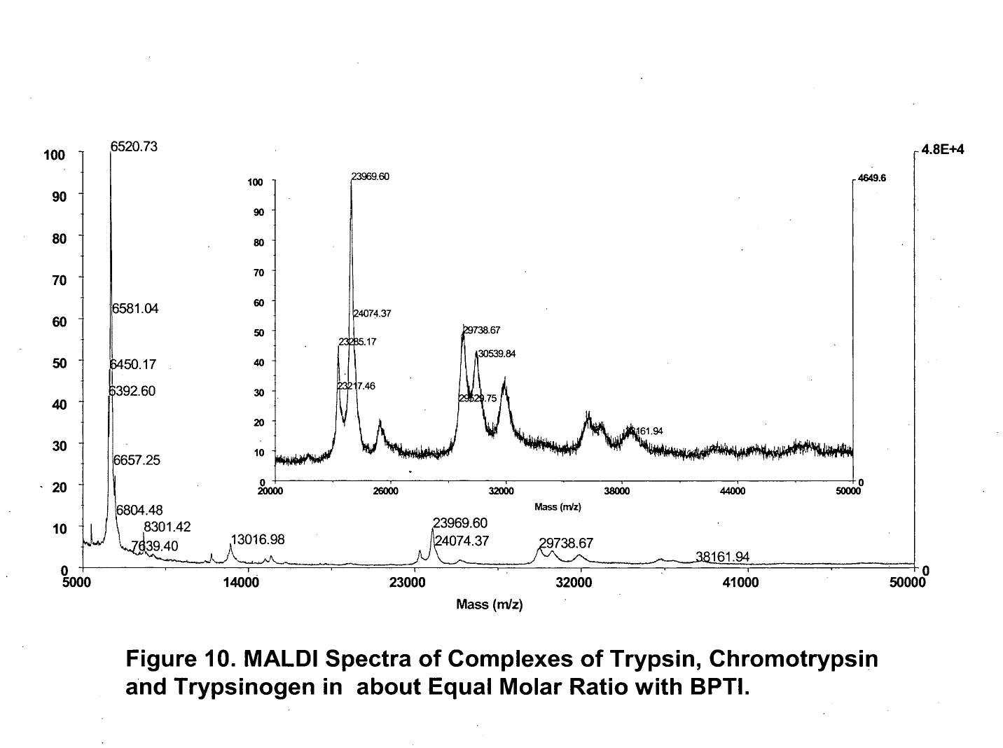

Bovine pancreatic trypsin inhibitor, trypsin, chymotrypsin, trypsinogen were purchased from Sigma-aldrich. The matrix solution was prepared by adding 25 mg of the sinapinic acid and 50 mg of ammonium citrate or ammonium hydrogen citrate in 1 mL of deionized water to give a saturated solution, then adjusted to pH7 with ammonium hydroxide. When bovine pancreatic trypsin inhibitor (BPTI, MW 6553) 2 uL of 200 uM in water was mixed with 2 uL of each of the three enzymes, trypsin, chymotripsin, trypsinogen in concentration of 50 uM in water. The final mixture was vortexed. Four sample spots were prepared by loading 1 uL of the final analyte mixture, the corresponding complexes were detected by MALDI (FIG. 10). This kind of experiment may indicate the relative affinity of the three complexes from the ratios of the bound complexes over the free enzyme. The results obtained show that chymotripsin-BPTI and trypsin-BPTI complexes may be stable than trypsinogen-BPTI complex, which agrees with the known binding affinity in solution, however the trypsin complex doesn't seems significantly stable than chymotrypsin complex.

1. A method for preparing a composition for studying biomolecular interactions under native condition by Matrix-assisted Laser Desorption and Ionization (MALDI); said composition is a buffered matrix solution comprising one matrix or more matrices with one additive or more additives in an essentially aqueous solvent at near physiological pH; said method comprising steps of:
(a) Preparing biomolecule or biomolecular complexes in an essentially aqueous solvent in the presence of the buffered matrix solution;
(b) Evaporating the sample mixture to dryness;
(c) Analyzing the sample by mass spectrometry.

2. The method of claim 1, wherein said composition further comprises the addition of one base or bases, or the addition of an acid or acids to adjust the pH of the buffered solution to near physiological pH.

3. The method of claim 1, wherein said biomolecular complex is peptide-protein complex.

4. The method of claim 1, wherein said biomolecular complex is protein-protein complex.

5. The method of claim 1, wherein said biomolecular complex is protein-nucleic acid complex.

6. The method of claim 1, wherein said essential aqueous solution contains water as the solvent without any organic solvent.

7. The method of claim 1, wherein said essential aqueous solvent contains water as the solvent; and with less than 5% of organic solvent.

8. The method of claim 7, wherein said organic solvent comprises methanol, ethanol, acetonitrile, dimethylsulfone.

9. The method of claim 1, wherein said matrix is a carboxylic acid.

10. The method of claim 1, wherein said matrix is selected from the group comprising of sinapinic acid, alpha.-cyano-4-hydroxycinnamic acid, 2,5-dihydroxybenzoic acid, 3-hydroxypicolinic acid, 5-(trifluoro-methyl)uracil, caffeic acid, succinic acid, anthranilic acid, 3-aminopyrazine-2-carboxylic acid, ferulic acid, 7-amino-4-methyl-coumarin, and 2-(4-hydroxyphenylazo)-benzoic acid.

11. The method of claim 1, wherein said additive is a compound to assist incorporation of protein or their complexes into matrix crystal after evaporation to dryness.

12. The method of claim 1, wherein said additive is volatile salt.

13. The method of claim 1, wherein said additive is an ammonium salt.

14. The method of claim 1, wherein said additive is selected from the group consisting of ammonium citrate, ammonium hydrogen citrate, ammonium bicarbonate, ammonium carbonate, ammonium acetate, ammonium tartarate, ammonium bicarbonate, methylammonium bicarbonate, dimethyl ammonium bicarbonate, or trimethyl ammonium bicarbonate, ethyl ammonium bicarbonate, diethyl ammonium bicarbonate, or triethyl ammonium bicarbonate.

15. The method of claim 1, wherein said pH of the matrix and additive mixture solution is adjusted to a pH 6-9 with one or more bases.

16. The method of claim 2, wherein said solution is adjusted to a near physiological pH with a base.

17. The method of claim 16, wherein said base is a volatile base.

18. The method of claim 17, wherein said volatile base is selected from the group consisting of ammonium hydroxide, methylamine, dimethylamine, trimethylamine, ethylamine, diethylamine, triethylamine or the combination.

19. The method of claim 2, wherein said base is selected from sodium hydroxide, sodium carbonate, sodium bicarbonate or any base.

20. The method of claim 1, wherein analyzing the sample by mass spectrometry comprises performing MALDI mass spectrometry.
